(19) United States
(12) Patent Application Publication
(10) Pub. No.: US 2017/0055472 A1
(43) Pub. Date: Mar. 2, 2017

(54) ROTARY PLANT GROWING APPARATUS

(71) Applicant: Orbital Technologies, Inc., Issaquah, WA (US)

(72) Inventor: Matt GUNTHER, Lyman, WA (US)

(21) Appl. No.: 14/841,556

(22) Filed: Aug. 31, 2015

(51) Int. Cl. A01G 31/06

(52) U.S. Cl. CPC A01G 31/06

(57) ABSTRACT

Provided herein is a rotary plant growing apparatus. The apparatus includes a base and a cylindrical assembly supported by the base. The cylindrical assembly has an open first end and defines an interior growing chamber. The cylindrical assembly is also selectively rotatable relative to the base. A plurality of cartridge retention members are disposed on an inner said of the cylindrical assembly. An annular retention frame is disposed at the open first end of the cylindrical assembly and is formed with an opening. A selectively movable cartridge is retained in said interior growing chamber by the first cartridge retention member and the annular retention frame. The annular retention frame is dimensioned and positioned relative to the cylindrical assembly such that the selectively movable cartridge is only movable relative to said cylindrical assembly when the cartridge and said opening are longitudinally aligned.

### FIELD

The present disclosure relates to horticulture, more specifically to hydroponic plant growth systems.

### BACKGROUND

Hydroponics is a method of growing plants using mineral nutrient solutions, in water, without soil. Two types of hydroponics are solution culture hydroponics and medium culture hydroponics. Solution culture hydroponics does not use a solid medium to support the roots; the roots are suspended in the nutrient solution culture. The three main types of solution cultures are static solution culture, continuous-flow solution culture and aeroponics (i.e. the roots are saturated with a mist of the nutrient solution). The medium culture method uses a solid medium to support the roots such as sand, gravel, or the like. A common hydroponic irrigation technique is sub-irrigation, where a fluid such as water mixed with nutrients, is introduced from below the roots of the plant.

It is known in the art that when plants are grown on a flat surface under a light source, the plants are at varying distances from the source and that greater efficiency in the use of the light may be obtained where all the plants being illuminated by a given light source are equidistant from it, reducing the number of lights needed for each productive square unit of growing area. This can be achieved by means of a rotary growing apparatus in which the plants are rotated about a light source at the axis of rotation, as is shown in U.S. Pat. No. 6,604,321, issued Aug. 12, 2003 to Marchildon.

In some applications however, inventory control of the plants being grown is critical. For example, some states regulate the marijuana industry at least in part by implementing what is known as a “seed to sale” process, wherein the state must be able to track the production of any and all marijuana based products for sale in the state. It is therefore important that an operator of a commercial scale hydroponic growing operation be able to track where any given plant is in the operation at any given time.

### BRIEF DESCRIPTION OF THE DRAWINGS

FIG. 1 is an isometric perspective view a rotary plant growing apparatus with a selectively removable cartridge partially removed from the rotary plant growing apparatus in accordance with at least one embodiment.

FIG. 2 is a top-down view of the rotatory plant growing apparatus shown in FIG. 1 with a selectively removable cartridge partially removed from the rotary plant growing apparatus.

FIG. 3 is a right-side view of the rotatory plant growing apparatus shown in FIG. 1 with a selectively removable cartridge partially removed from the rotary plant growing apparatus.

FIG. 4 is a front view of the rotatory plant growing apparatus shown in FIG. 1 with a selectively removable cartridge partially removed from the rotary plant growing apparatus.

FIG. 5 is a left-side view of the rotatory plant growing apparatus shown in FIG. 1 with a selectively removable cartridge partially removed from the rotary plant growing apparatus.

FIG. 6 is a rear view of the rotatory plant growing apparatus shown in FIG. 1 with a selectively removable cartridge partially removed from the rotary plant growing apparatus.

FIG. 7A is an isometric perspective view of a selectively removable cartridge with plants disposed therein in accordance with at least one embodiment.

FIG. 7B is an isometric perspective view of a selectively removable cartridge without plants disposed therein in accordance with at least one embodiment.

FIG. 7C is a first cross-sectional view of the selectively removable cartridge illustrated in FIG. 7B.

FIG. 7D is a first cross-sectional view of the selectively removable cartridge illustrated in FIG. 7B.

FIG. 8 illustrates several components of an exemplary rotary plant growing apparatus control unit in accordance with at least one embodiment.

FIG. 9 illustrates exemplary network topology of a rotary growing control system in accordance with at least one embodiment.

FIG. 10 illustrates several components of an exemplary growing system control server in accordance with at least one embodiment.

FIG. 11 is a control flow diagram of an exemplary rotary plant growing apparatus control routine in accordance with at least one embodiment.

### DESCRIPTION

In the detailed description that the phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

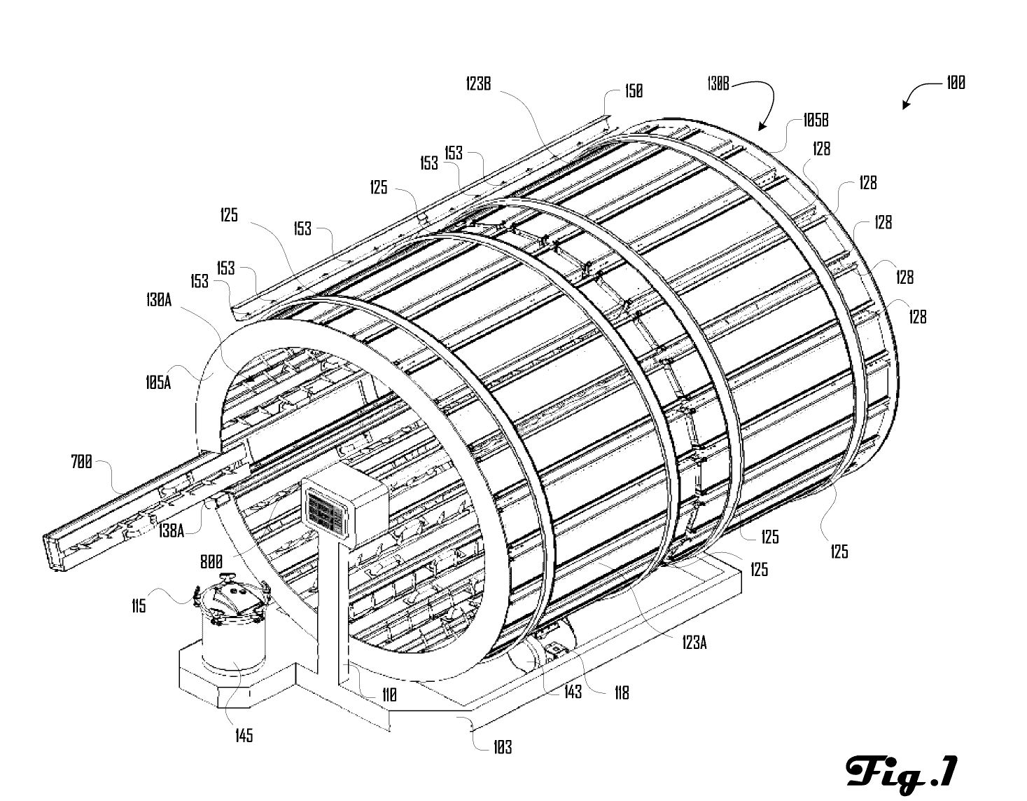

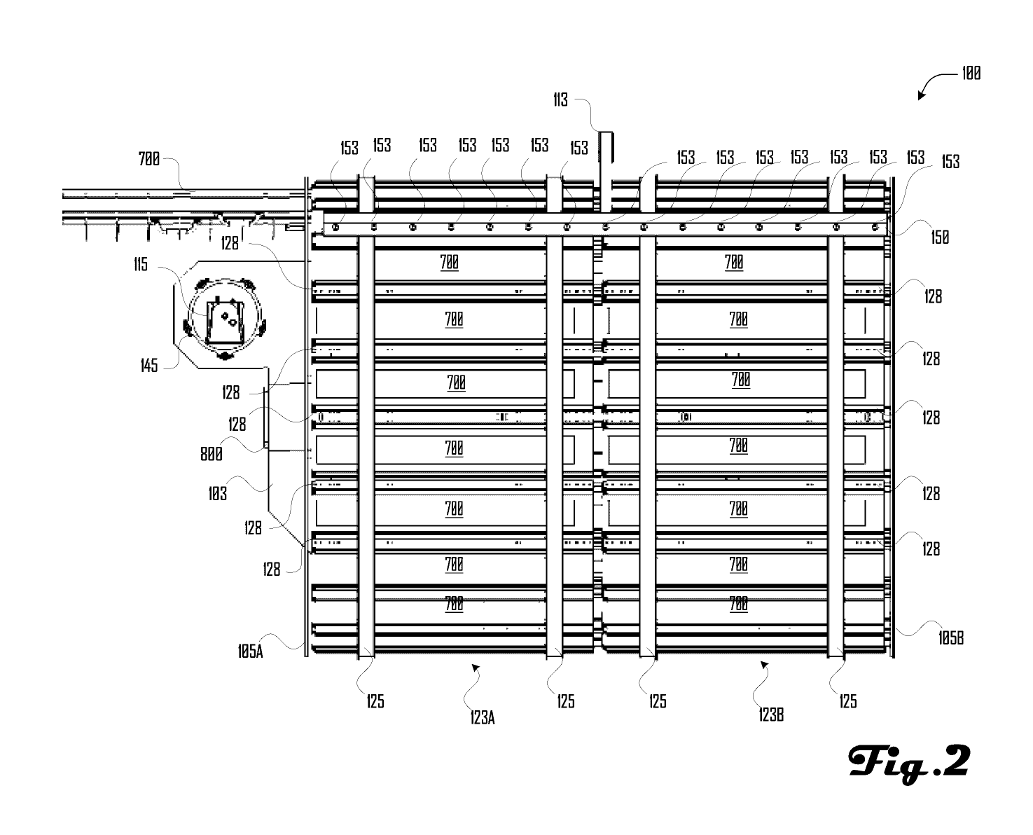

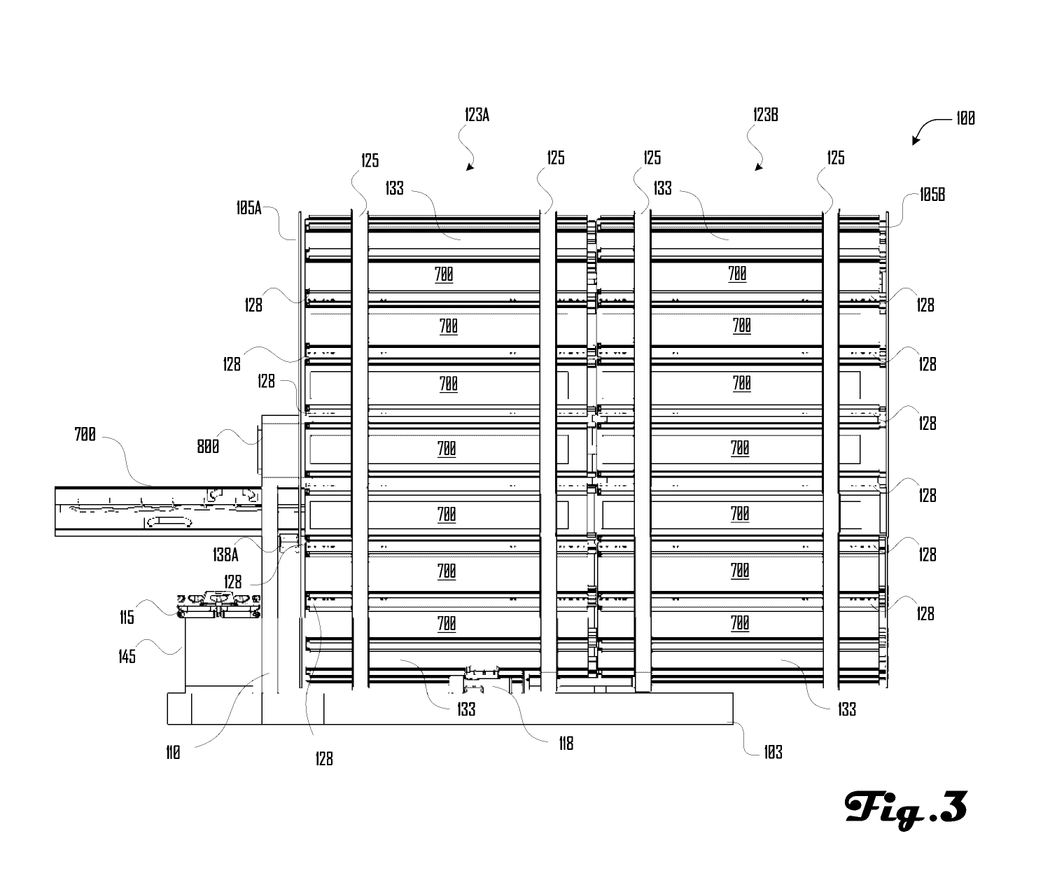

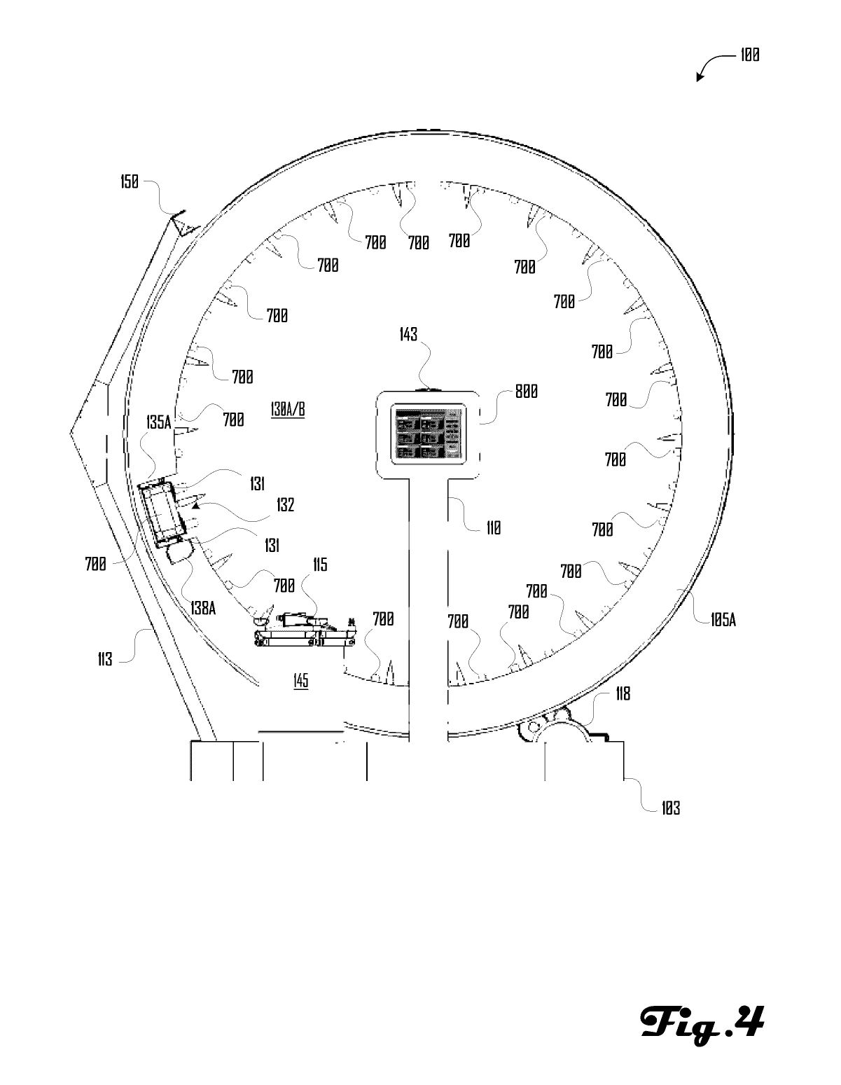

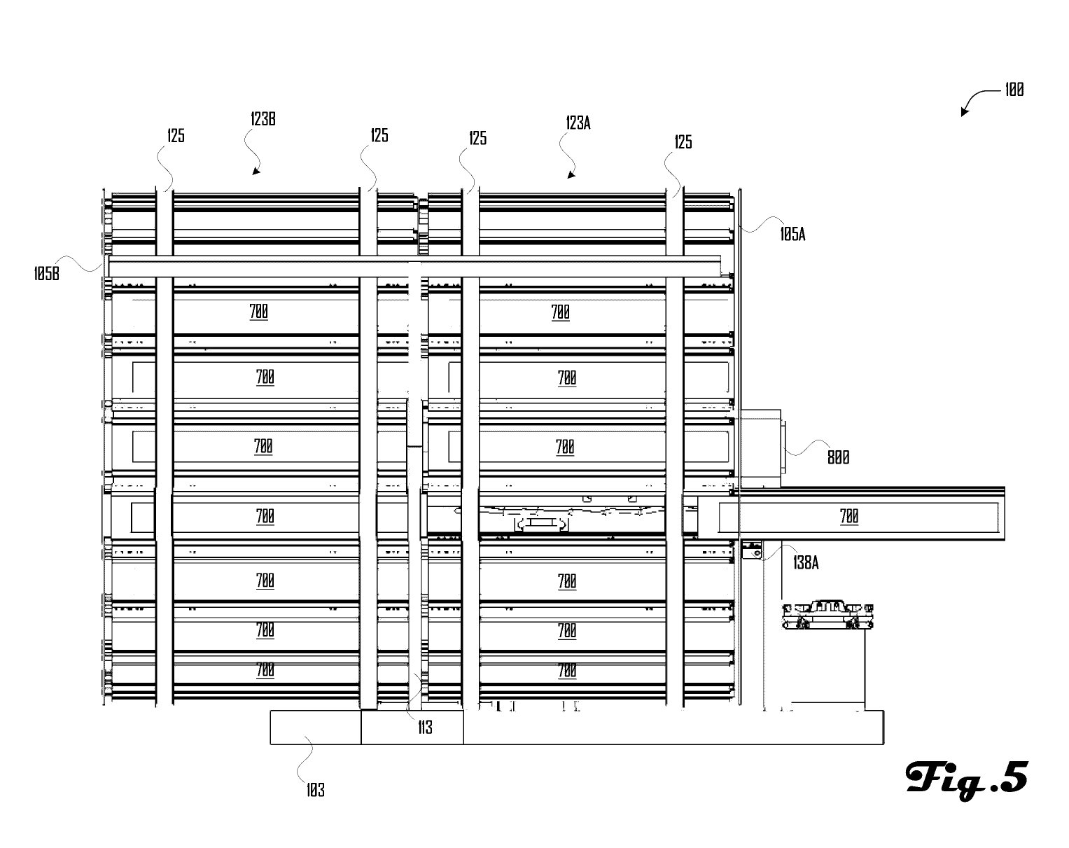

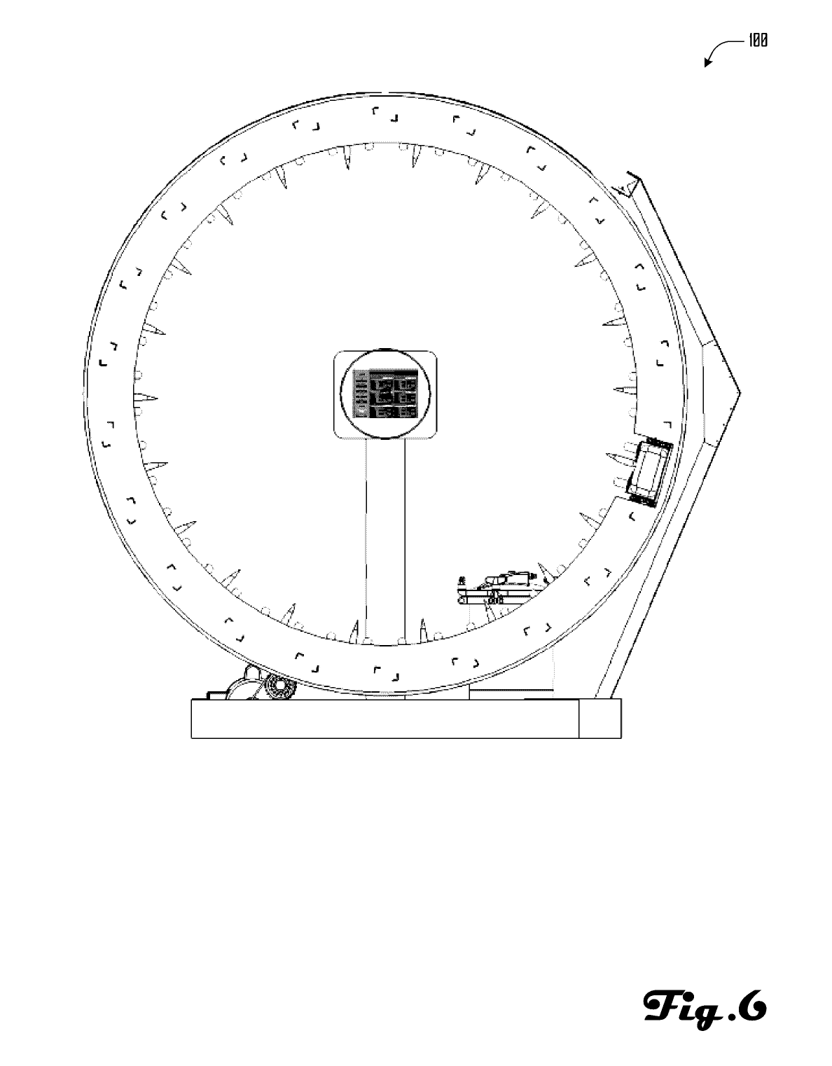

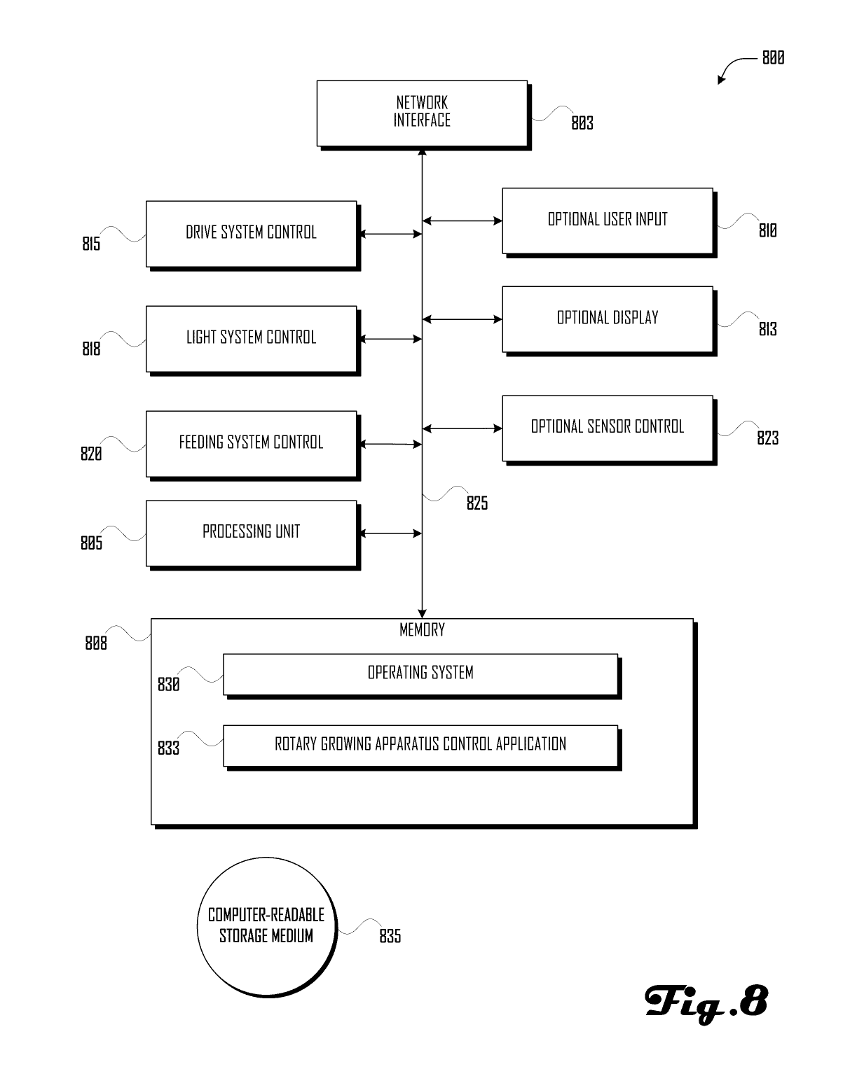

FIGS. 1-6 illustrate a rotary growing apparatus 100 in accordance with at least one embodiment. Rotary growing apparatus 100 includes a base 103, front and rear annular retention frames 105A-B, a light source support member 110, a feeding bar support member 113, a feeding control system 115, a drive system 118, and a control unit 800, described below in reference to FIG. 8.

Base 103 is formed with a drainage area 121 and supports front and rear annular retention frames 105A-B, light source support member 110, feeding bar support member 113, feeding system 115, drive system 118, and control unit 800.

Front and rear cylindrical assemblies 123A-B may be disposed above base 103 between front and rear annular retention frames 105A-B. Each of front and rear cylindrical assemblies 123A-B are rotatable relative to front and rear annular retention frames 105A-B and include support rings 125 joined by longitudinal support bars 128, which collectively define generally cylindrical front and rear interior growing chambers 130A-B. Opposing pairs of cartridge retention members 131 extend radially from longitudinal support bars 128 into interior growing chambers 130A-B. Each opposing pair of cartridge retention members 131 may define a cartridge slot 132. As is described below, cartridges 700 are selectively disposable within cartridge slots 132. Opposing pairs of cartridge retention members 131 constrain radial and circumferential movement of cartridges 700 relative to front and rear cylindrical assemblies 123A-B. Front and rear annular retention frames 105A-B constrain axial movement of cartridges 700 relative to front and rear cylindrical assemblies 123A-B.

Front and rear annular retention members 105A-B are each formed with an opening 135A-B, permitting axial movement of a cartridge 700 relative to front and rear cylindrical assemblies 123A-B when the cartridge is disposed directly in front of the opening. Front and rear inventory scanning units 138A-B are disposed adjacent tor respective openings 135A-B. Inventory scanning units 138A-B may, for example, be bar code scanners, QR code readers, or other optical sensing devices for reading inventory control information on cartridges 700 being placed in and/or removed from interior growing chambers 130A-B via openings 135A-B, respectively.

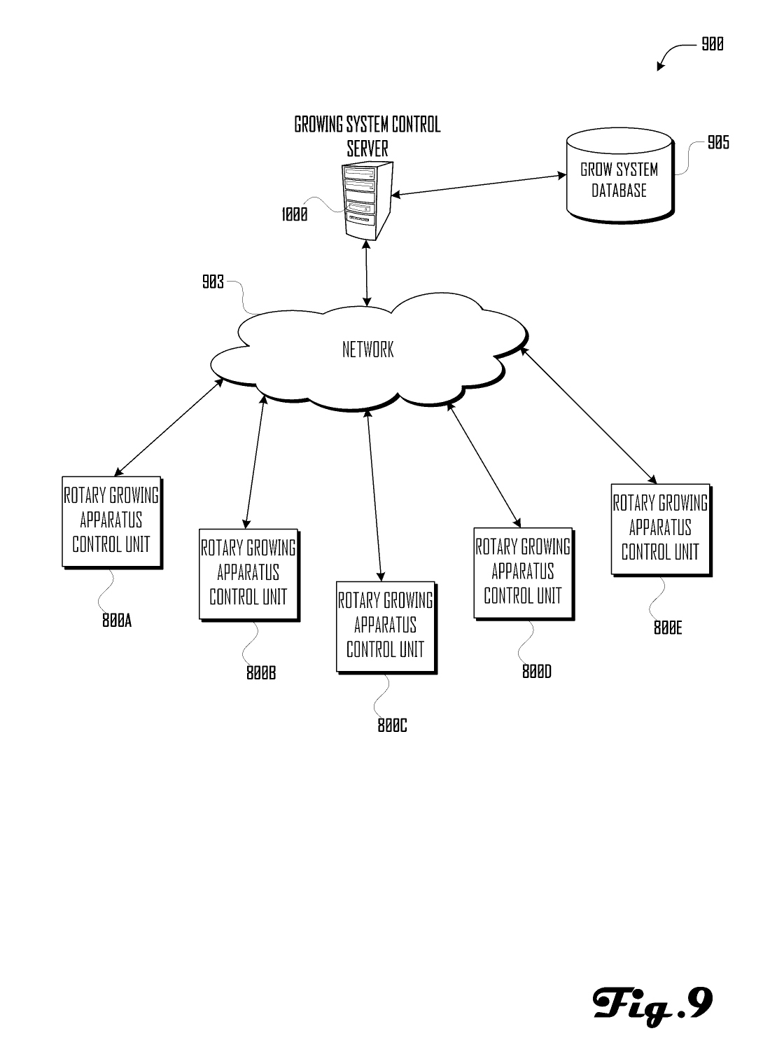

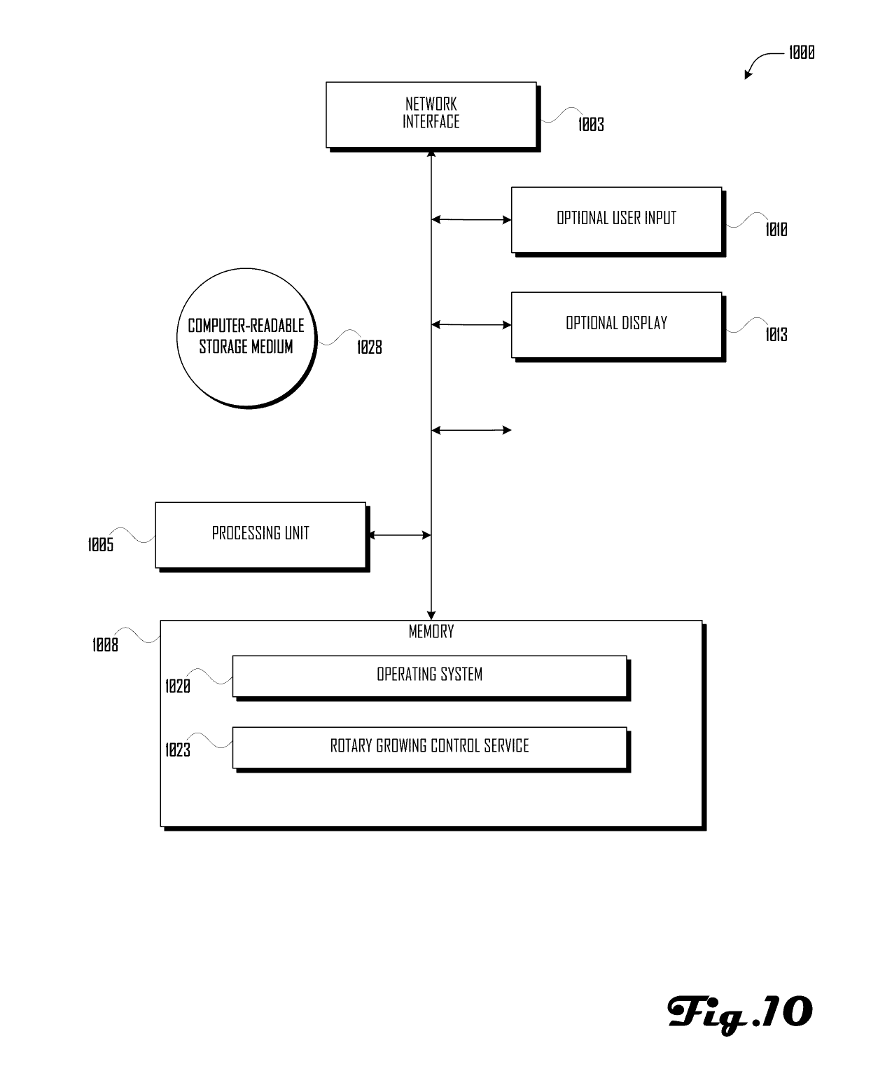

As is described below, control unit 800 may be in data communication with various components of rotary growing apparatus 100. Control unit 800 may also be in data communication with a growing control system server 1000, described below in reference to FIG. 10, via a network interface 805. The functional components of an exemplary control unit 800 are described below in reference to FIG. 8. As is described in more detail below, control unit 800 obtains operation instructions for rotary growing apparatus 100, e.g. via an optional user input 810, network 903 (see FIG. 9), and/or the control unit's internal memory 808, and controls the operation of rotary growing apparatus 100 accordingly.

Optional sensors 140 may be selectively disposed within interior growing chambers 130A-B. Optional sensors 140 may be in data communication with control unit 800. As is described in more detail below, optional sensors 140 may collect data relating to the environment inside interior growing chambers 130A-B during the operation of rotary growing apparatus 100, such as data relating to temperature, humidity, light intensity and wavelength, fluid levels, rotation speed, plant growth, plant health, and the like.

Drive system 118 may include a motor 143 operatively connected to front and rear cylindrical assemblies, e.g. via support rings 125, in order to selectively rotate the front and rear cylindrical assemblies relative to front and rear annular retention members 105A-B. The operation of drive system 118 may be selective controlled by control unit 800, for example in response to data received from sensors 140 and/or in response to instructions received via user interface 810 and/or network interface 803.

Light source support member 110 extends upwardly from base 103. An axial light source 143 may be supported by light source support member 110 and extend across interior growing chambers 130A-B, e.g. coaxially with front and rear cylindrical assemblies 123A-B. The operation of light source 143 may be selectively controlled by control unit 800, for example in response to data received from sensors 140 and/or in response to instructions received via user interface 810 and/or network interface 803.

Feeding control system 115 may include a reservoir 145 and a pump 148. Feeding bar support member 113 may support a feeding bar 150 disposed over an upper portion of front and rear cylindrical assemblies 123A-B. Feeding bar 150 may be formed with ports 153 generally oriented in the direction front and rear cylindrical assemblies 123A-B and in fluid communication with reservoir 145. Pump 148 may selectively control the delivery of fluid from reservoir 145 to ports 153. The operation of pump 148 may be controlled by control unit 800, may be selectively controlled by control unit 800, for example in response to data received from sensors 140 and/or in response to instructions received via user interface 810 and/or network interface 803.

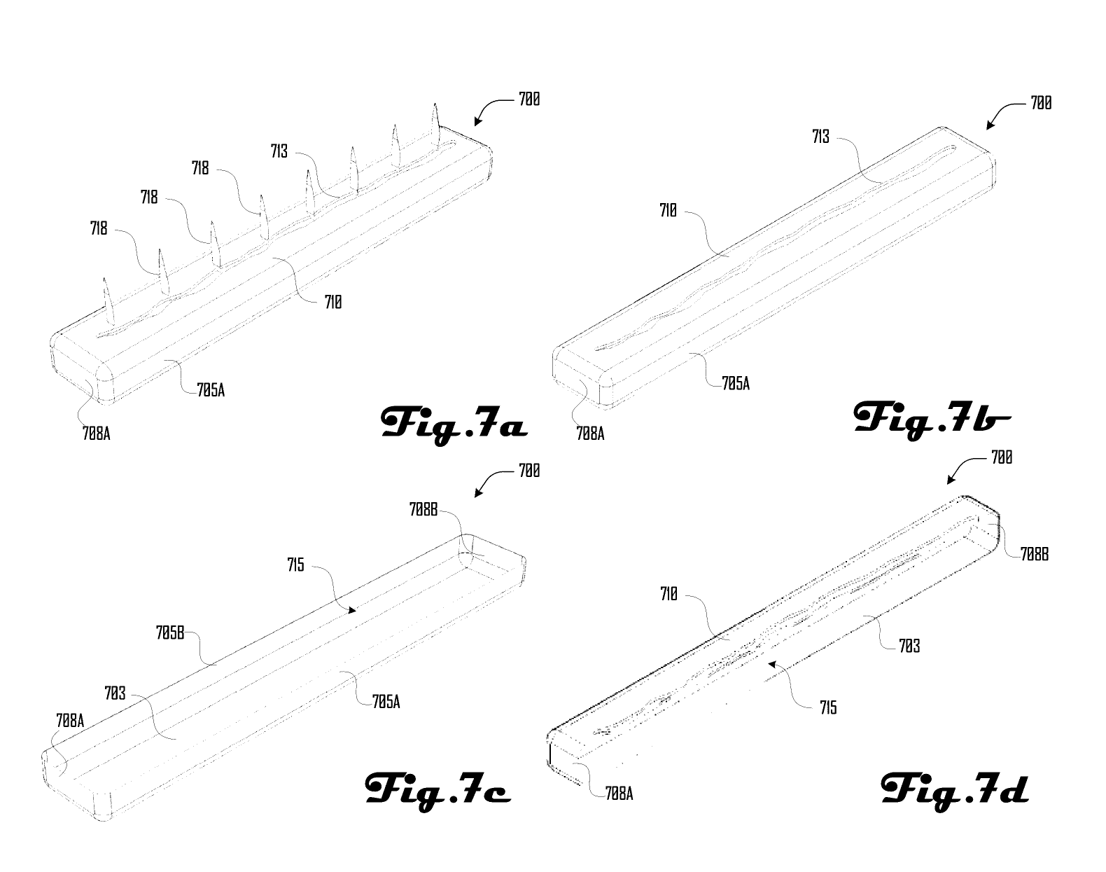

FIGS. 7a-d illustrate an exemplary cartridge 700 in accordance certain aspects of at least one embodiment for selective installation in rotary growing apparatus 100. Selectively removable cartridge may include a floor 703, opposing longitudinal walls 705A-B extending upwardly from the floor, opposing end walls 708A-B extending upwardly from the floor between the opposing longitudinal walls, and a ceiling 710 opposing the floor and extending from the longitudinal walls and the end walls. Floor 703 may be formed with one or more drip holes (not shown) and ceiling 710 may be formed with a slot 713. Floor 703, longitudinal walls 705A-B, end walls 708A-B, and ceiling 710 may collectively define an interior chamber 715.

Plants 718 are selectively disposable within interior chamber 715. Roots may form within interior chamber 715 and receive nourishment via drip holes (not shown). Stems may extend outwardly from interior chamber 715 through slot 713.

Inventory identifiers 720, such a bar code, a QR code, or the like, may be affixed to one or more exterior sides of cartridge 700.

The operation of a rotary growing apparatus, such as rotary growing apparatus 100, in accordance with various embodiments will now be described.

Interior chamber 715 of cartridge 700 may be at least partially filled with a plant growing medium (not shown) and one or more plants 718. Cartridge 700 may then be placed back into one of interior growing chambers 130A-B by orienting the selected cylindrical assembly 123 such that an opposing pair of cartridge retention members 131 is disposed directly in front of opening 135. Cartridge 700 may then be moved through opening 135 and installed between opposing pair of cartridge retention members 131. In accordance with various inventory control schemes, inventory identifiers 720 may be scanned by inventory scanning unit 138 as cartridge 700 moves through opening 135. This process may be selectively repeated for each opposing pair of cartridge retention members. Control unit 120 may provide information obtained from inventory identifiers 720 to growing system control server Y00.

After the desired number of plants 718 have been placed in cartridges 700 and the cartridges have been secured inside interior growing chambers 130A-B, control unit 800 may (1) selectively engage drive system 118 such that front and rear cylindrical receiving assemblies 123A-B rotate about light source 143 at a desired rate; (2) selectively engage light source 143 such that plants 718 disposed in the interior growing chambers are exposed to a desired intensity and wavelength of light; and/or (3) selectively engage feeding control system such that a desired amount of the contents of reservoir 145 flows through ports 153 of feeding bar 150 into each cartridge 700 as the cartridge passes under the feeding bar. The rate of rotation supplied by drive system 118, the intensity and wavelength of the light supplied by light source 143, and the amount of fluid delivered by feeding system 115, may all be at least partially dependent on information obtained from inventory identifiers 720.

When one or more of plants 718 in cartridge 700 have reached a desired state of growth, the cartridge may be removed from interior growing chamber 130 by orienting the selected cylindrical assembly 123 such that the cartridge is disposed directly in front of opening 135. Cartridge 700 may then be removed from between opposing pair of cartridge retention members 131 and out through opening 135. In accordance with various inventory control schemes, inventory identifiers 720 may be scanned by inventory scanning unit 138 as cartridge 700 moves through opening 135. This process may be selectively repeated for one or more cartridges installed within front and rear interior growing chambers 130A-B. Control unit 120 may provide information obtained from inventory identifiers 720 to growing system control server Y00.

FIG. 8 illustrates several components of an exemplary control unit 800, in accordance with various embodiments. In some embodiments, a control unit 800 may include many more components than those shown in FIG. 8. However, it is not necessary that all of these generally conventional components be shown in order to disclose an illustrative embodiment. As shown in FIG. 8, exemplary control unit 800 includes a network interface 803 for connecting to a network, a processing unit 805; and a memory 808. Exemplary control unit 800 may also include an optional user input 810 (e.g. an alphanumeric keyboard, keypad, a touchscreen, and/or a microphone), and/or an optional display 813. Exemplary control unit may also include drive system control 813 for providing control signals to and/or obtaining feedback from drive system 118; light system control 818 for providing control signals to and/or obtaining feedback from light source 143; feeding system control 820 for providing control signals to and/or obtaining feedback from feeding control system 115; and/or sensor control 823 for providing control signals to and/or obtaining feedback from optional sensors 140. All of these components may be may be interconnected via a bus 825. Memory 808 generally comprises a RAM, a ROM, and a permanent mass storage device, such as a disk drive, flash memory, or the like.

Memory 808 of exemplary control unit 800 may store an operating system 830 as well as program code for a number of software applications, such as a rotary growing apparatus control application 833, described below. Program code for these and other such software applications or components may be loaded from a non-transient computer readable storage medium 835 into memory 808 using a drive mechanism (not shown) associated with the non-transient computer readable storage medium, such as, but not limited to, a DVD/CD-ROM drive, memory card, or the like. Software components may also be loaded into memory 808 via the network interface 803, rather than via a computer readable storage medium 833.

Although an exemplary control unit 800 has been described, a control unit 800 may be any of a great number of networked computing devices capable of communicating with a network and executing program code, such as the program code corresponding to rotary growing apparatus control application 833. In some embodiments, a control unit 800 may comprise one or more replicated and/or distributed physical or logical devices.

FIG. 9 illustrates an exemplary rotary growing control system 900 in accordance with various embodiments. A growing control system server 1000 (described below with reference to FIG. 10) and one or more rotary growing apparatus control units 800, such as rotary growing apparatus control units 800A-E, may be in data communication with a network 903. In various embodiments, network 903 may include the Internet, one or more local area networks (“LANs”), cellular data networks, and/or other data networks. Network 903 may, at various points, be wired and/or wireless networks.

Growing control system server 1000 is a networked computing device generally capable of providing/obtaining requests over network 903, and obtaining/providing responses accordingly. Growing control system server 1000 may be in data communication with a grow system database 905.

Each rotary growing apparatus control unit 800A-E may, as is described above, be data communication with other rotary growing system components and and/or with network 103. A rotary growing apparatus in a rotary growing control system does not need to be physically connected to, or be in physical proximity of, network and/or other rotary growing apparatuses to be considered part of the rotary growing control system. For example, rotary growing systems 100A-D may be located in a first physical location, rotary growing system 100E may located in a second physical location, and growing system control system Y00 may be located in a third physical location while all still being in data communication via network 103 and still considered part of the same rotary growing control system ZOO.

FIG. 9 is intended to depict a simplified example of a rotary growing control system in accordance with various embodiments. In many other embodiments there may be many more rotary growing apparatuses than are depicted in FIG. 9.

FIG. 10 illustrates several components of an exemplary growing system control server 1000, in accordance with at least one embodiment. In some embodiments, growing system control server 1000 may include many more components than those shown in FIG. 10. However, it is not necessary that all of these generally conventional components be shown in order to disclose an illustrative embodiment. As shown in FIG. 10, growing system control server 1000 includes a network interface 1003 for connecting to a network, such as network 903. Growing system control server 1000 also includes a processing unit 1005 and a memory 1008, and may also include an optional user input 1010 and an optional display 1013, all interconnected along with the network interface 1003 via a bus 1018. Memory 1008 generally comprises a random access memory (“RAM”), a read only memory (“ROM”), and a permanent mass storage device, such as a disk drive.

Memory 1008 stores an operating system 10200 and program code for various software services, such as rotary growing control service 1023. Program code for these and other such software applications or components may be loaded from a non-transient computer readable storage medium 1028 into memory 1008 using a drive mechanism (not shown) associated with the non-transient computer readable storage medium, such as, but not limited to, a DVD/CD-ROM drive, memory card, or the like. Software components may also be loaded into memory 1008 via the network interface 1003, rather than via a computer readable storage medium 1028. Threat assessment server 1000 may also communicate via bus 1018 and/or network interface 1003 with a database, such as grow system database 905, or other local or remote data stores (not shown). In some embodiments, a threat assessment server 1000 may comprise one or more replicated and/or distributed physical or logical devices.

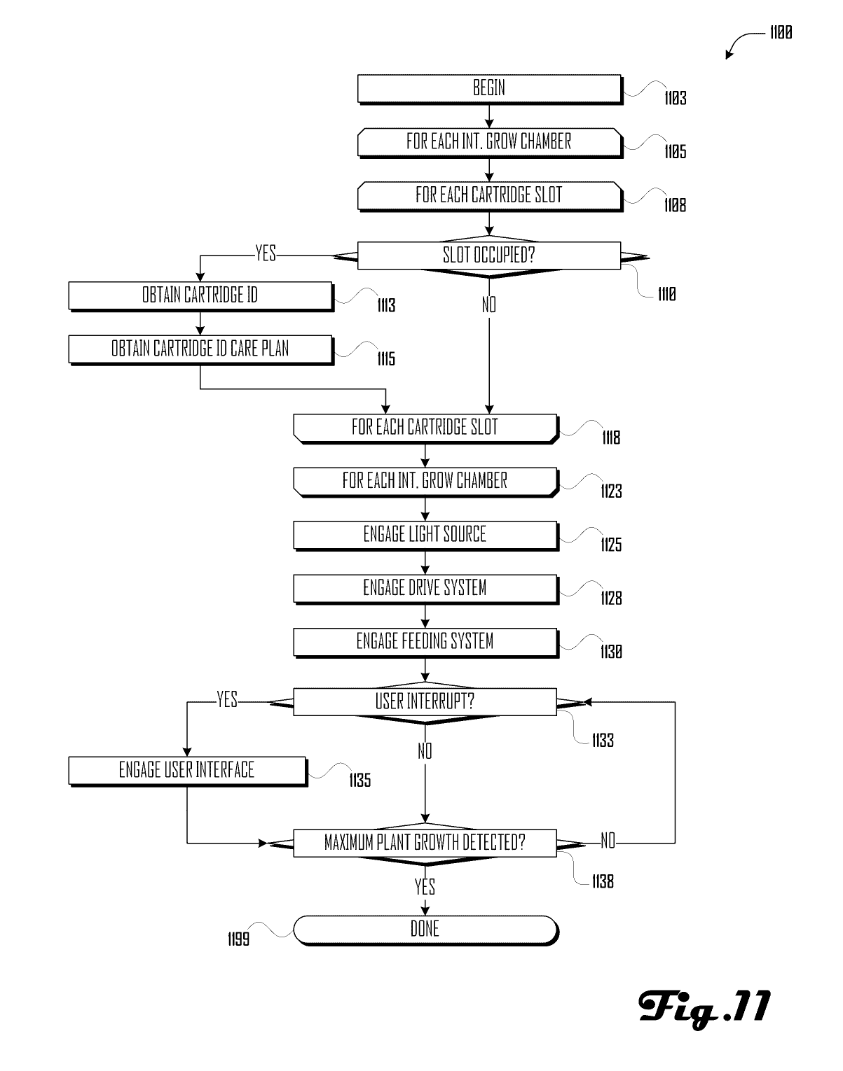

FIG. 11 illustrates a rotary growing apparatus control routine 1100, which may be implemented by rotary growing apparatus control application 833 operating on control unit 800.

Routine 1100 initiates at beginning block 1103. At starting loop block 1105, routine 1000 addresses each interior growing chamber 130 in turn. At starting loop block 1109, routine 1100 addresses each cartridge slot 134 in turn.

At decision block 1110, if the current cartridge slot 132 is occupied, i.e. with a cartridge 700, routine 1100 proceeds to execution block 1103; otherwise routine 1100 proceeds to ending loop block 1118.

At execution block 1113, routine 1100 obtains a cartridge identifier associated with the current cartridge slot 132. For example, control unit 800 may maintain a cartridge slot table including associated cartridge identifiers in memory 808.

Routine 1100 obtains a cartridge care plan associated with the cartridge identifier at execution block 1115. For example, control unit 800 may provide growing system control server 1000 with a cartridge care plan request including the cartridge identifier. Growing system control server 1000 may respond by providing a cartridge care plan associated with the cartridge identifier. The cartridge care plan may include information relating to the desired light exposure, nutritional intake, and the like of plants disposed within the cartridge.

At ending loop block 1118, routine 1000 loops back to starting loop block 1108 to process the next cartridge slot. At ending loop block 1123, routine 1000 loops back to starting loop block 1105 to address the next interior growing chamber.

After each interior growing chamber has been addressed, routine 1000 may engage light source 143 at execution block 1125, engage drive system 115 at execution block 1128, and feeding system 118 at execution block 1130.

At decision block 1133, if routine 1100 obtains a user interrupt, e.g. via optional user input 810, routine 1100 may engage a user interface at execution block 1135; otherwise routine 1100 proceeds to decision block 1138.

At decision block 1138, if routine 1100 detects that one or more plants in one of the interior growing chambers has reached a maximum degree of plant growth, e.g. a plant is coming into proximity of light source 143, routine 1100 may terminate at termination block 1199; otherwise routine 1100 may loop back to decision block 1133.

Although specific embodiments have been illustrated and described herein, a variety of alternate and/or equivalent implementations may be substituted for the specific embodiments shown and described without departing from the scope of the present disclosure. This application is intended to cover any adaptations or variations of the embodiments discussed herein.

1. A rotary plant growing apparatus comprising:
a base;
a cylindrical assembly supported by said base, said cylindrical assembly having an open first end, defining an interior growing chamber, and being selectively rotatable relative to said base;
a plurality of cartridge retention members disposed on an inner said of said cylindrical assembly, including a first cartridge retention member;
an annular retention frame disposed at said open first end of said cylindrical assembly, said annular retention frame being formed with an opening;
an optical scanner disposed adjacent to said opening; and
a selectively movable cartridge, retainable in said interior growing chamber by at least said first cartridge retention member and said annular retention frame;
wherein said annular retention frame is dimensioned and positioned relative to said cylindrical assembly such that said selectively movable cartridge is only movable relative to said cylindrical assembly when said cartridge and said opening are longitudinally aligned.
